(19) United States
(12) Patent Application Publication
(10) Pub. No.: US 2007/0253560 A1
(43) Pub. Date: Nov. 1, 2007

(54) System And Method For Spotting Unexpected Noise For Forecasting Aberrant Events

(76) Inventor: YAKOV TOPOR, TEL AVIV (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/380,941

(22) Filed: May 1, 2006

(51) Int. Cl. H04R 29/00

(52) U.S. Cl. 381/58

(57) ABSTRACT

Noise-based monitoring systems and methods use unexpected noise (UEN) events to identify developing processes in an observed system. A monitoring system includes a general noise pattern (GNP) unit for receiving and processing a GNP spectrum from the observed system, a typical general noise (TGN) unit for eliminating all TGN components from the processed GNP spectrum in order to obtain unexpected noise (UEN) data and a UEN processor unit for processing the UEN data. The monitoring system may also be used for relaying a distress signal from an originating source to a destination

### FIELD OF THE INVENTION

The present invention relates to systems and methods that can detect and process unexpected noise (UEN) events in noise patterns obtained form a system under observation, thereby providing information on an aberrant process or event developing in these observed systems.

### BACKGROUND OF THE INVENTION

Noise is a pervasive by product of the activity occurring in many systems. Each system has a measurable general noise pattern (GNP). Each system also generates a typical general noise (TGN) that is also measurable. The TGN may include of one or more types of noise or noise components. The components may represent “normal” signal noise and environmental noise. The TGN spectrum or pattern of each system (e.g. a power or electrical network, a machine, seismic environment, etc.) may be processed into a “fingerprint” of the noise expected from that system. This expected noise is considered “normal” for the particular system.

The monitoring of TGN may include calculations or measurements that may involve various transformations into different forms or “languages”. The transformed data may be counted/analyzed by a system implemented in hardware (HW), software (SW) or a combination of HW/SW. The output of such monitoring/transformed data represents the expected “normal” TGN for the particular system or environment. The normal pattern/value may even be standardized for each particular system, and be considered the “TGN fingerprint” of that system.

FIGS, 1-3 show exemplary known noise patterns. FIG. 1 shows an exemplary, relatively high frequency (5 kHz) background noise pattern measured in an electrical power outlet in an industrial zone FIG. 2 shows an exemplary basic (50 Hz) frequency noise pattern measured in the same power outlet.

FIG. 3. shows an exemplary machine noise pattern, with relatively uniformly spaced (periodic along a time axis) events 300 representing a typical machine noise “fingerprint”. Any significant deviation from the normal TGN fingerprint of a system may be considered as “not normal” or “unexpected”.

The present inventor is unaware of any use of noise in prior art as means for monitoring and identifying an aberrant process or event developing in an observed system. In particular, the present inventor is unaware of any indication in prior art for use of “unexpected noise” components for monitoring or any other purpose.

### SUMMARY OF THE INVENTION

The present invention provides innovative ways to detect, process and use unexpected noise events in a noise spectrum for monitoring and identifying processes developing in an observed system. The present invention discloses systems and methods that monitor TGN spectra or patterns to detect and process unexpected noise components, and optionally provide a warning on impending danger based on the detected unexpected noise. Any aberrant process or event detected using the system and method of the present invention is referred to hereinafter as “developing process”.

The present inventor has determined that a GNP of an observed system may include noise components that do not fit (or “belong”) to, and are not expected in the TGN of that system. The present inventor has further determined that these unexpected noise components can be measured or deduced from noise measurements. In some cases, they may indicate the development of a “positive” process such as the discovery of a heretofore unknown or unexpected process. In other cases, they may indicate the development of a “negative” process such as a danger, a disaster, a mishap, a fire, an earthquake, a disease, etc. This negative process will be referred to henceforth as a “potential or impending” problem. A system and method of the present invention may monitor and detect both positive and negative process developments. In the case of the latter, the system and method may further provide an alert or warning about the potential problem.

According to the present invention there is provided a noise-based monitoring system including a GNP unit for receiving and processing a GNP spectrum from an observed system, a TGN unit for eliminating all TGN components from the processed GNP spectrum in order to obtain UEN data, and a UEN processor unit for processing the UEN data, whereby the processed UEN data can be used for monitoring, detecting and identifying a process developing in the observed system.

According to the present invention there is provided a noise-based electrical power grid monitoring system including an adapter connectable to the power grid, a GNP unit for receiving and processing a GNP from the power grid through the adapter, a TGN unit for eliminating all TGN components from the processed GNP in order to obtain UEN data, and a UEN processor unit for processing the UEN data and for determining, based on the processed UEN data, whether a hazard is developing in the electrical power grid.

In one embodiment, the hazard is a fire hazard.

In one embodiment, the system further includes alarm means for producing an alarm if a hazard is found developing.

According to the present invention there is provided a method for detecting a developing process in an observed system including the steps of: identifying at least one UEN component in noise data obtained from the observed system and determining if each identified UEN component is indicative of a developing process.

In some embodiments of the method, the step of identifying a UEN component includes receiving and processing a GNP from the observed system, eliminating all TGN components from the processed GNP in order to obtain UEN data, and processing the UEN data to identify UEN components.

In some embodiments of the method, the step of receiving and processing the GNP includes receiving and processing the GNP is an operation selected from the group consisting of continuous and non-continuous receiving and processing.

In some embodiments of the method, the step of processing the UEN data includes determining if the developing process is a negative process.

In some embodiments of the method, the determining if the developing process is a negative process includes determining if the UEN components are significant and recurring.

In some embodiments the method further includes the step of, if negative process development is established, issuing an alert.

In an embodiment in which the observed system is an electrical power grid, the determining if the developing process is a negative process includes determining if the process is a fire.

According to the present invention there is provided a system for relaying a distress signal from an originating source to a destination including: at the originating source, a UEN generator for generating and transmitting a synthetic UEN event (or “component”) to a carrier system having a GNP and a known TGN, wherein the synthetic UEN is incorporated in the GNP and, at the destination, a noise-based monitoring subsystem for receiving the GNP from the carrier system and for identifying the synthetic UEN event from the GNP.

According to the present invention, the noise-based monitoring subsystem includes a GNP unit for receiving and processing the GNP spectrum, a TGN unit for eliminating all TGN components from the processed GNP spectrum in order to obtain UEN data, and a UEN processor unit for processing the UEN data and for identifying the synthetic UEN event.

In one embodiment, the system for relaying a distress signal from an originating source to a destination the carrier system is an electrical power grid system.

### BRIEF DESCRIPTION OF THE DRAWINGS

For a better understanding of the present invention and to show more clearly how it could be applied, reference will now be made, by way of example only, to the accompanying drawings in which:

FIG. 1 shows schematically an exemplary high frequency background noise pattern measured in an electrical power outlet in an industrial zone;

FIG. 2 shows an exemplary basic (50 Hz) frequency noise pattern measured in an electrical power outlet in an industrial zone;

FIG. 3 shows an exemplary machine noise pattern;

FIG. 4 shows schematically a general noise pattern that includes periodically spaced typical general noise components and an unexpected noise component;

FIG. 5a shows schematically a block diagram of a UEN-based monitoring and detection system according to the present invention;

FIG. 5b shows details of one embodiment of the TGN unit of FIG. 5a;

FIG. 5c shows a more detailed view of the system in FIG. 5;

FIG. 6 shows an embodiment of the system of FIG. 5, as applied to UEN-based detection of potential hazards (e.g. a fire) in an electrical power grid;

FIG. 7 shows an exemplary temporal UEN pattern, obtained after various filtering operations.

FIG. 8 shows a UEN-based monitoring and detection system of the present invention used for relay of remote emergency or distress calls;

FIG. 9 shows details of a synthetic UEN event generator.

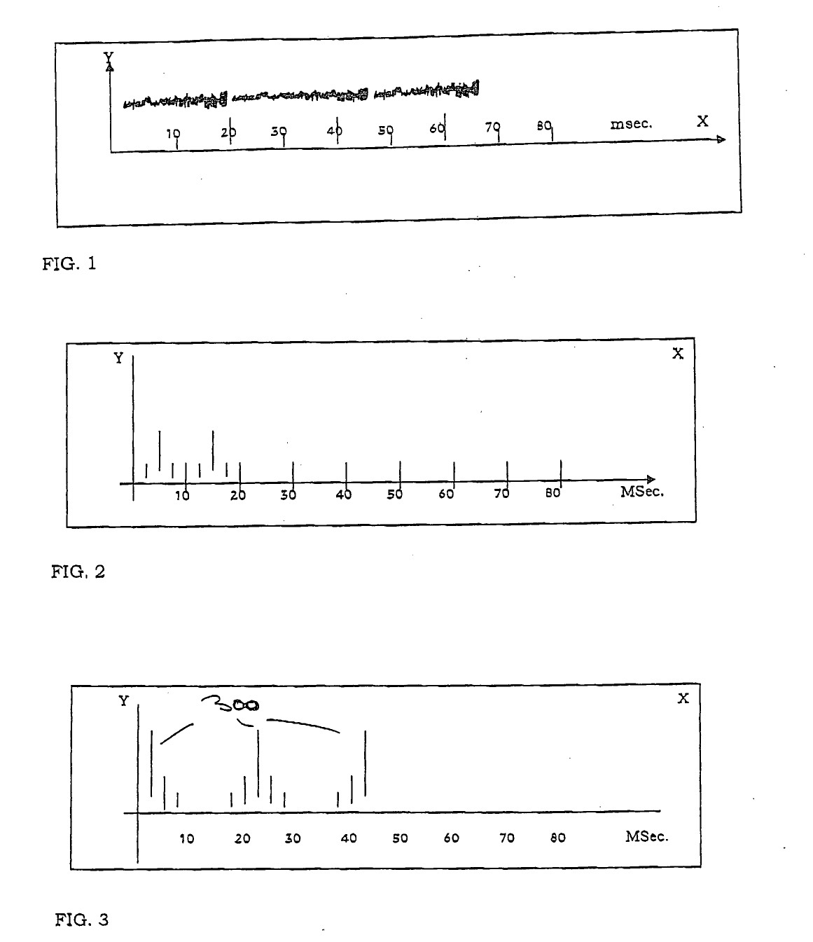

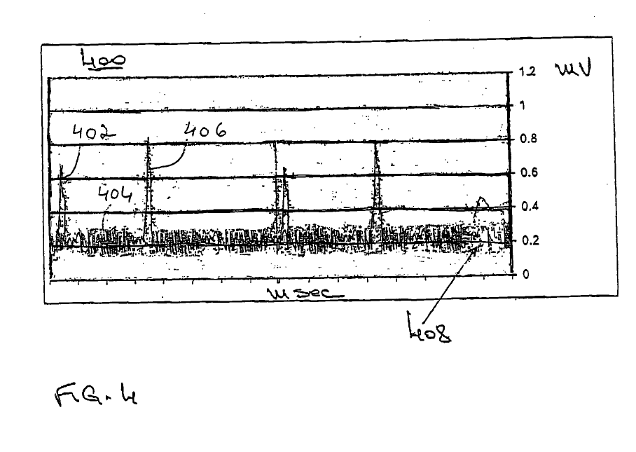

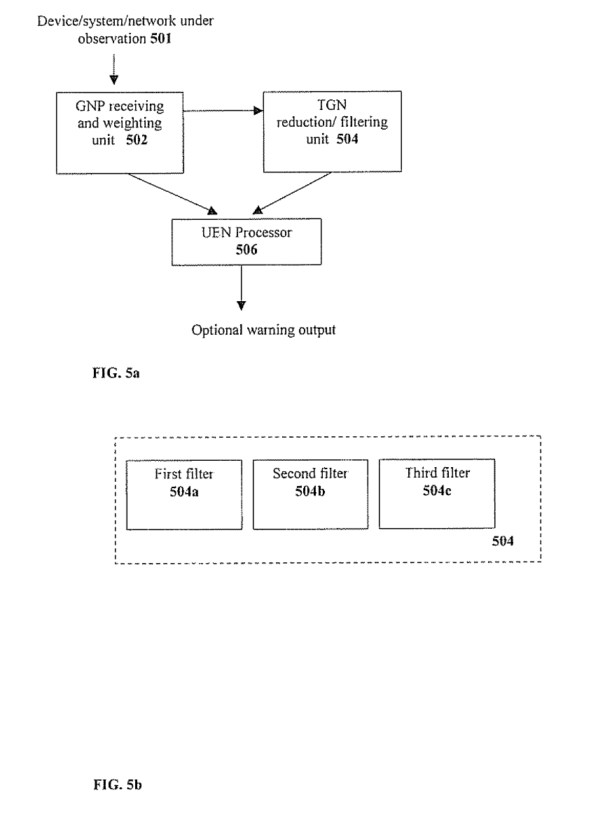

### DETAILED DESCRIPTION OF THE PREFERRED EMBODIMENTS

A basic assumption of the present invention is that one can measure or count the general noise pattern (GNP) of a given system or of particular system components at any time. The GNP can be measured and/or counted either continuously or periodically, on-line or off-line, using one or more known measurement techniques, including mechanical, electrical, acoustical and optical techniques. Schematically, the GNP includes the known TGN (simulated, calculated or fitted) “fingerprint” of that system/component and is identical to the TGN when the system is non-perturbed. When the system or some of its components experience a disrupting “event” (or “perturbation”), e.g. an event that affects in any way the “normal” functioning of the system, the GNP will change and will differ from the TGN fingerprint. The changed GNP will now include a UEN component (perturbation noise component) that is not part of the normal TGN. In other words, the measured changed GNP=TGN+UEN. The detection of any UEN in a measurement/count may indicate the presence of a respective potentially disruptive event. In some contexts, described in more detail below, this indication can be considered as “warning” of an impending danger.

Note that the principle of “UEN event detection” on which the present invention is based is different from that of signal detection. The character of UEN is undefined. Using the present invention, everything in a noise pattern that is “expected” is either erased, ignored and/or filtered out in a comparison-based process (deduction of TGN from GNP), so by definition whatever remains after these actions has to be “unexpected”. Thus, “unexpected noise” as used herein cannot be defined a-priori in any way and cannot be searched or looked for. For illustration, FIG. 4 shows an exemplary GNP 400 that includes periodically spaced “normal” (i.e. TGN) noise components 402, 404 and 406 and an exemplary UEN component 408. Components 402 and 406 represent machine or other equipment noise and are “expected”, being known a-priori. Component 404 represents background noise and is also expected. UEN component 408 lacks any uniformity or periodicity relative to the TGN and thus cannot be “expected”.

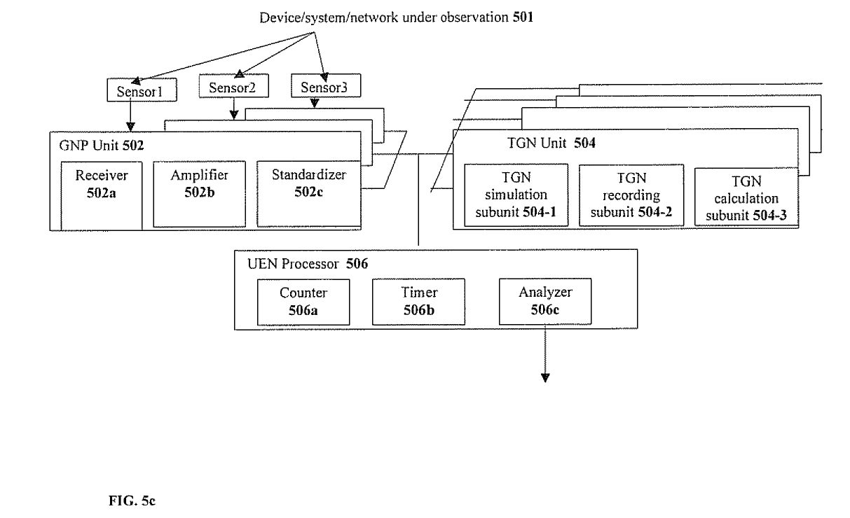

FIG. 5a shows schematically a block diagram of a UEN-based monitoring and detection system 500 according to the present invention. The main purpose of system 500 is to monitor the GNP of an observed device/system/network(501 and to detect UEN events. Exemplarily, the device may be a machine such as a car, an airplane, a motor, a mechanical processing machine, an electronic assembly, a semiconductor processing apparatus, a computer mainframe, an electrical device, an acoustic device, a seismic device, etc. Exemplarily, the system may be an electrical power grid, an earthquake or tidal wave monitoring system, a chemical monitoring system, a flood monitoring system, a pipeline monitoring system, etc. Further exemplarily, the network may include a communications network, an electrical network or an electronic network. In the most general sense, any device, system or network that can be coupled to and provide a GNP to the monitoring system of the present invention falls under the definition of device/system/network 501. For simplicity, 501 is referred to herein only as “observed system”. System 500 includes a GNP receiving and weighting unit 502 for receiving a GNP (also referred to as general noise spectrum) from the observed system, for defining a noise measurement interval and for providing one or more weight-based importance factors System 500 further includes a TGN unit 504 for filtering, removing or “deducting” all TGN components (i.e the entire TGN spectrum) from the GNP spectrum and for outputting UEN data, and a UEN processor unit 506 for processing the UEN data and, optionally, for outputting a warning based on this processing.

For some application related e g. to electrical grid monitoring, the removal of the TGN components from the GNP in TGN unit 504 may be done by one or more deducting subunits, commonly referred to herein as “filters”. When more than one, each filter may operate on a different TGN component. For example, in an embodiment shown in FIG. 5b, TGN unit 504 includes a first filter 504a operative to filter fixed/background or periodic noise components, a second noise filter 504b, operative to filter machine noise or environmental noise and a third noise filter 504c operative to filter, expected noise or noise typical to the observed system. The various filtering functions work in combination to remove all TGN components (i.e. the entire TGN spectrum), thus leaving only UEN components (if present) intact to pass through to UEN processor unit 506. The filtering operation may be done in parallel or in series. The filters may be implemented in separate units or in one combined unit.

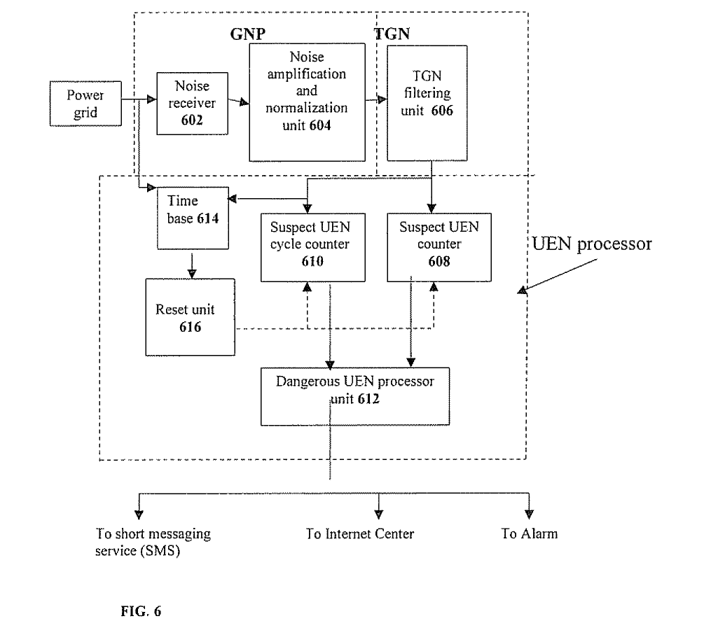

FIG. 5c shows more details of one embodiment of the system in FIG. 5a. In general, adaptors or “sensors” are positioned as an interface between observed system 501 and GNP unit 502. FIG. 6 shows three such adaptors (marked as sensor1 , sensor2 and sensor3), although obviously a number other than 3 is possible. The adaptors are used for collecting and/or translating input noise data from observed system 501. Each adaptor may be connected to a separate unit 502, with all GNP outputs of units 502 fed to the TGN unit. Each GNP unit 502 includes a receiver 502a to for receiving the input data, an optional amplifier 502b for amplifying low or weak input data and an optional standardization unit 502c for preparing the input data to be leveled and weighted on a standard comparison scale. Each TGN unit 504 may include one or more subunits, for example, a TGN simulation subunit 504-1 that can provide at least a part of the TGN spectrum by simulation, a TGN recording subunit 504-2 that can provide at least a part of the TGN spectrum by copying the same part from a “real” spectrum and a TGN calculation subunit 504-3 that can build a fit to at least a part of the TGN spectrum by calculations. The simulated, calculated or fitted TGN spectrum is then used in a comparison-based test to remove the TGN components from the GPN spectrum. UEN processor 506 includes a counter 506a for counting UEN, a timing subunit 506b for determining time-based tests and an analyzer subunit 506c for analyzing the results of these tests. It should be clear that while all units in FIG. 5a are essential, some of the subunits in FIG. 5c may be left out in some embodiments.

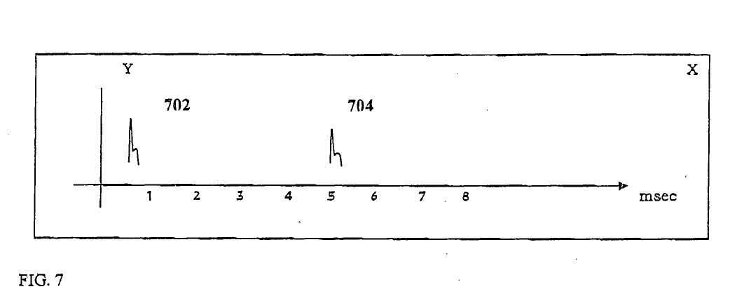

FIG. 6 shows an embodiment of the system of FIG. 5, as applied to UEN-based detection of potential hazards (e g. a fire) in an electrical power grid. The power grid is the observed system. Power grid GNP is received in a noise receiver 602 and, if necessary, the GNP is amplified and normalized in unit 604. TGN components are eliminated in unit 606, which now outputs GNP-TGN components to the UEN processor. The processor includes a UEN counter 608 that counts “suspect” UEN events seen in the GNP-TGN output, a UEN cycle counter 610 that tracks cycles of such suspect UEN events; a dangerous UEN processor unit 612 that can process UEN events to determine if they represent a hazard (see FIG. 7 and Example below); a time-base unit 614 to provide a time-base for the counters; and a rest unit 616 for resetting the counter/s. If the UEN processor determines that the UEN events indicate a potential or impending hazard, it can trigger and alarm or output warning information to a customer through various known means such as through a SMS center or the Internet.

FIG. 7 shows an exemplary temporal UEN pattern obtained at UEN processor 506. The pattern includes two “suspect” events 702 and 704. The events are analyzed to determine whether they are indicative of an impending dangerous hazard, such as an electrical cause for a fire. In principle, the analysis seeks to determine if each of the two events occurs more than once (is recurring) and if it is random (“insignificant”) or non-random (“significant”). A number of tests may be run: one test may determine whether tile UEN event is unexpected and non-recurring (significant and recurring), by, for example searching for another UEN event in the pattern within a predetermined time period (e.g, within 0.09 sec) after the current event. If another event is not found, then the event is defined as harmless or “insignificant”. A second test may check whether the UEN events occur at a frequency greater than a predetermined threshold, for example sequentially m times (m being an integer equal or greater than 2) one after the other. If both tests are affirmative, a warning is issued by unit 512 that the UEN pattern may indicate a potential hazard. A third test may now be run to determine whether the hazard is real or not. This test may for example include the presence of n (e.g. 3) such consecutive warnings within a given period p (e.g. 3 seconds). If affirmative, a “real” warning of impending danger may be sent to a customer/automatic danger response entity.

### EXAMPLE

### Testing for Fire Danger Arising from Bad Electrical Contact in a Power Grid

The test is run through a regular electrical socket. The noise measurement interval is defined as “continuous” by unit 502 (or unit 602 in FIG. 6). First noise filter 504a is an analog filter for (exemplarily) frequencies above 2 KHz and below 10 Hertz Second noise filter 504b is a 50 Hz, digital window filter, allowing a window of 0.005 sec pass around sine zero crossing points. Third noise filter 504c is a digital noise band pass filter that normalizes the noise amplitude: when the noise amplitude is lower than a minimum threshold, filter 504c sets a value of 0. When the noise amplitude is higher than a maximum threshold, filter 504c sets a value of 1.

Assume that the filtering yielded a UEN event. The following tests are now run: A first test checks if there is another UEN event in the pattern in the predetermined time period (0.09 sec). If the result is affirmative (“pass”), a second test checks if there are 9 UEN events that “pass” the first test within 0.81 sec. If the result of the second test is also affirmative (“pass”), a third test checks if there is another UEN event within 3 sec of the end of the second test. If the UEN events pass all three tests, a warning is issued. If not, the processor resets the counter.

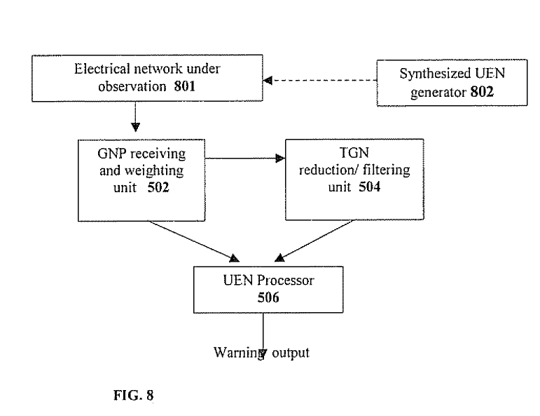

FIG. 8 shows yet another use of a UEN-based system 800 of the present invention, this time for relay of remote emergency or distress calls. System 800 includes an additional synthetic or “artificial” UEN generator 802 that can generate “artificial” UEN events, which are referred to henceforth as “distress signals”. UEN generator 801 is coupled to an electrical system under observation 801 (which serves here as a “carrier system”), which is further coupled to system 800 as described above with reference to FIGS. 5-6. The artificial UEN events are distinctly different from the TGN of electrical system 801 and can be synthesized based on pre-knowledge of this TGN. When added to the GNP of system 801, the artificial UEN events plus the TGN of system 801 reach a monitoring system 500 of the present invention and are processed in a UEN processor therein as described above, identified as indicating an emergency and used to generate a warning relayed to an appropriate body. In one example, the distress signals may be generated by a patient at home and relayed to a medical response emergency center.

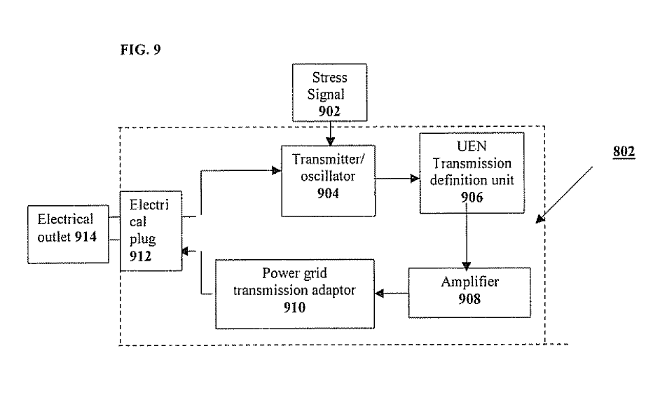

Specifically, as shown in FIG. 9, artificial UEN generator 802 may include a transmitter oscillator 904 configured to receive a synthesized UEN stress signal 902, a UEN transmission definition unit 906 used to define and shape signal 902, an amplifier 908 used to amplify a weak shaped signal, a transmission adaptor 910 used for impedance matching and isolation, and an electrical plug 912 through which the generator is coupled to an electrical grid outlet 914.

In summary, the present invention provides innovative ways to detect, process and use UEN events in a noise spectrum of an observed system for monitoring and identifying processes developing in the observed system. The present invention further provides a way for relaying a distress signal based on incorporation of synthetic UEN events into the GNP of a carrier system observed by a noise based monitoring system of the present invention.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A noise-based monitoring system comprising:
a. a general noise pattern (GNP) unit for receiving and processing a general noise pattern from an observed system;
b. a typical general noise (TGN) unit for eliminating all TGN components from the processed GNP in order to obtain unexpected noise (UEN) data; and
c. a UEN processor unit for processing the UEN data; whereby the processed UEN data can be used for monitoring, detecting and identifying a process developing in the observed system.

2. The system of claim 1, further comprising coupling means for connecting the GNP unit to the observed system.

3. The system of claim 2, wherein the developing process is a negative process.

4. The system of claim 3, wherein the observed system is an electrical power grid selected from the group consisting of a local grid and a non-local grid.

5. The system of claim 4, wherein the negative developing process includes a developing fire hazard.

6. The system of claim 3, wherein the UEN processor is operative to identify the negative process from the processed UEN data and to provide a warning related to the negative process.

7. The system of claim 3, wherein the observed system is selected from the group consisting of a machine, a network, an electrical system, an electronic system, a seismic system, a flood system and a chemical system.

8. A noise-based electrical power grid monitoring system comprising:
a. an adapter connectable to the power grid.
b. a general noise pattern (GNP) unit for receiving and processing a general noise pattern from the power grid through the adapter;
c. a typical general noise (TGN) unit for eliminating all TGN components from the processed GNP in order to obtain unexpected noise (UEN) data; and
d. a UEN processor unit for processing the UEN data and for determining, based on the processed UEN data, whether a hazard is developing in the electrical power grid.

9. The system of claim 8, wherein the hazard is a fire hazard.

10. The system of claim 8, further comprising alarm means for producing an alarm if a hazard is found developing.

11. A method for detecting a developing process in an observed system comprising the steps of:
a. identifying at least one unexpected noise (UEN) component in noise data obtained from the observed system; and
b. determining if each identified UEN component is indicative of a developing process.

12. The method of claim 11, wherein the step of identifying a UEN component includes:
i. receiving and processing a general noise pattern (GNP) from the observed system,
ii. elimninating all typical general noise (TGN) components from the processed GNP in order to obtain UEN data, and
iii. processing the UEN data to identify UEN components.

13. The method of claim 12, wherein the step of receiving and processing the GNP includes receiving and processing the GNP is an operation selected from the group consisting of continuous and non-continuous receiving and processing.

14. The method of claim 12, wherein the step of processing the UEN data includes determining if the developing process is a negative process.

15. The method of claim 14, wherein the determining if the developing process is a negative process includes determining if the UEN components are significant and recurring.

16. The method of claim 14, further comprising the step of, if negative process development is established, issuing an alert.

17. The method of claim 11, wherein the observed system is an electrical power grid and wherein the determining if the developing process is a negative process includes determining if the process is a fire.

18. A system for relaying a distress signal from an originating source to a destination comprising:
a at the originating source, an unexpected noise (UEN) generator for generating and transmitting a synthetic UEN event to a carrier system having a general noise pattern (GNP) and a known typical general noise (TGN), wherein the synthetic UEN is incorporated in the GNP; and
b. at the destination, a noise-based monitoring subsystem for receiving the GNP from the carrier system and for identifying the synthetic UEN event from the GNP;

19. The system of claim 18, wherein the noise-based subsystem includes:
i. a GNP unit for receiving and processing the GNP,
ii. a TGN unit for eliminating all TGN components from the processed GNP in order to obtain UEN data, and
iii. a UEN processor unit for processing the UEN data and for identifying the synthetic UEN event.

20. The system of claim 19, wherein the carrier system is an electrical power grid system.
